(19) United States
(12) Patent Application Publication
(10) Pub. No.: US 2024/0427063 A1
(43) Pub. Date: Dec. 26, 2024

(54) ELECTRONIC DEVICE

(71) Applicant: InnoLux Corporation, Miao-Li County (TW)

(72) Inventors: Chih-Chang CHEN, Miao-Li County (TW); Bo-Tsuen CHEN, Miao-Li County (TW)

(21) Appl. No.: 18/671,185

(22) Filed: May 22, 2024

(30) Foreign Application Priority Data
Jun. 20, 2023 (CN) 202310734295.4

(51) Int. Cl. G02B 5/04

(52) U.S. Cl. CPC G02B 5/045; G02B 6/0053

(57) ABSTRACT

An electronic device includes: a backlight module; a panel disposed on the backlight module; a viewing angle control element disposed between the backlight module and the panel; and a light modulation element disposed between the panel and the viewing angle control element. The light modulation element has a plurality of prism structures, and at least one of the plurality of prism structures includes a first bottom angle and a second bottom angle. The first bottom angle is larger than the second bottom angle, and a ratio of the first bottom angle to the second bottom angle satisfies 1<the first bottom angle/the second bottom angle≤15.

### CROSS REFERENCE TO RELATED APPLICATIONS

This application claims priority of China Patent Application No. 202310734295.4, filed Jun. 20, 2023, the entirety of which is incorporated by reference herein.

### BACKGROUND OF THE INVENTION

### Field of the Invention

The present disclosure relates to an electronic device, and in particular, to a light modulation element.

### Description of the Related Art

Electronic devices are used in various fields in everyday life. The viewing angles of the output light from different electronic devices (for example, display devices) may have various designs according to the application requirements. Therefore, how to adjust the viewing angle of an electronic device while maintaining a high manufacturing yield is a contemporary issue that needs to be addressed.

### BRIEF SUMMARY OF THE INVENTION

An embodiment of the present disclosure provides an electronic device, the electronic device includes a backlight module; a panel disposed on the backlight module; a viewing angle control element disposed between the backlight module and the panel; and a light modulation element disposed between the panel and the viewing angle control element. The light modulation element has a plurality of prism structures, and at least one of the plurality of prism structures includes a first bottom angle and a second bottom angle. The first bottom angle is larger than the second bottom angle, and a ratio of the first bottom angle to the second bottom angle satisfies 1<the first bottom angle/the second bottom angle ≤15.

Another embodiment of the present disclosure provides an electronic device, the electronic device includes a panel; a protective substrate disposed on the panel; and a light modulation element disposed between the panel and the protective substrate. The light modulation element has a plurality of prism structures, and at least one of the plurality of prism structures comprises a first bottom angle and a second bottom angle. The first bottom angle is larger than the second bottom angle. A ratio of the first bottom angle to the second bottom angle satisfies 1<the first bottom angle/the second bottom angle≤15.

### BRIEF DESCRIPTION OF THE DRAWINGS

The disclosure can be more fully understood from the following detailed description when read with the accompanying figures. It is worth noting that, in accordance with standard practice in the industry, various features are not drawn to scale. In fact, the dimensions of the various features may be arbitrarily increased or reduced for clarity of discussion.

FIG. 1 is a cross-sectional view of an electronic device, according to some embodiments of the present disclosure.

FIG. 2 is an enlarged view of the electronic device shown in FIG. 1, according to some embodiments of the present disclosure.

FIG. 3A is an optical diagram of an electronic device, according to some comparative examples.

FIG. 3B is an optical diagram of the electronic device, according to some embodiments of the present disclosure.

FIGS. 4A and 4B are cross-sectional views of various designs of light modulation elements, according to some embodiments of the present disclosure.

FIGS. 5A and 5B are top views of various designs of electronic devices, according to some embodiments of the present disclosure.

FIG. 6 is a cross-sectional view of an electronic device, according to other embodiments of the present disclosure.

FIGS. 7 and 8 are simulated optical diagrams of various designs of electronic devices, according to some embodiments of the present disclosure.

FIG. 9 is a cross-sectional view of an electronic device, according to other embodiments of the present disclosure.

FIG. 10 is a cross-sectional view of an electronic device, according to other embodiments of the present disclosure.

### DETAILED DESCRIPTION OF THE INVENTION

The following disclosure provides many different embodiments, or examples, for implementing different features of the subject matter provided. Specific examples of components and arrangements are described below to simplify the present disclosure. These are, of course, merely examples and are not intended to be limiting. For example, a first feature is formed on a second feature in the description that follows may include embodiments in which the first feature and second feature are formed in direct contact, and may also include embodiments in which additional features may be formed between the first feature and second feature, so that the first feature and second feature may not be in direct contact. In addition, the present disclosure may repeat reference numerals and/or letters in the various examples. This repetition is for the purpose of simplicity and clarity, and does not in itself dictate a relationship between various embodiments and/or configuration discussed.

The direction-related terms mentioned in the context, such as “up,” “down,” “front,” “back,” “left,” “right,” and the like, merely refers to the relative direction in the figures. Therefore, the direction-related terms are for illustration, and they are not intended to limit the present disclosure.

Furthermore, in some embodiments of the present disclosure, terms that describe a joining or connecting action, such as “connect”, “interconnect”, or the like, unless otherwise defined, may include embodiments in which two features are formed in direct contact, and they may also include embodiments in which additional features may be formed between the two features. Regarding the terms, such as “connect”, “interconnect”, or the like, may also include embodiments in which the two features are both mobile, or the two features are both fixed. Furthermore, terms, such as “electrically connected”, “coupled”, or the like, may include any means to directly or indirectly establish electrical connection.

In addition, terms, such as “the first”, “the second”, or the like, mentioned in the specification or the claims are only used to name different elements or to distinguish different embodiments or examples, and they are not intended to limit the upper limit or the lower limit of the element quantity, and they are also not intended to limit the manufacturing order or the placement order of the elements.

In the present disclosure, the terms “about,” “approximately” and “substantially” typically mean±20% of the stated value, more typically ±10% of the stated value, more typically ±5% of the stated value, more typically ±3% of the stated value, more typically ±2% of the stated value, more typically ±1% of the stated value, and even more typically ±0.5% of the stated value. The stated value of the present disclosure is an approximate value. That is, when there is no specific description of the terms “about,” “approximately” and “substantially”, the stated value includes the meaning of “about,” “approximately” or “substantially”.

Unless otherwise defined, all terms (including technical and scientific terms) used herein have the same meaning as commonly understood by one of ordinary skill in the art to which this disclosure belongs. It should be understood that terms such as those defined in commonly used dictionaries should be interpreted as having a meaning that is consistent with their meaning in the context of the prior art and will not be interpreted in an idealized or overly formal sense unless expressly so defined in the embodiments of the present disclosure.

Some variations of the embodiment are described. In different figures and illustrated embodiments, like reference numerals and/or letters are used to label like elements. It should be appreciated that additional operations can be provided before, during, and/or after the methods described in these embodiments. Additional features can be added to the semiconductor device structure. Some of the operations described below can be replaced or eliminated for different embodiments of the methods.

Throughout the context, each direction is not limited to perpendicular coordinates (such as x-axis, y-axis, and z-axis), and may be interpreted in a broader scope. For example, x-axis, y-axis, and z-axis may be perpendicular with each other, or they can represent different directions that are not perpendicular with each other. For ease of illustration, in the following context, x-axis is a lengthwise direction, y-axis is a widthwise direction, and z-axis is a thickness direction. In the embodiments of the present disclosure, z-axis is a normal direction of the substrate plane. In the embodiments of the present disclosure, top views refer to the observation of the x-y plane. In some embodiments, the first direction D1, the second direction D2, and the third direction D3 may be directions on the x-y plane. In some embodiments, the dimensions in different directions may be measured using optical images (for example, an image obtained by a scanning electron microscope (SEM)).

In the embodiments of the present disclosure, electronic devices may include a display apparatus, a backlight apparatus, an antenna apparatus, a sensor apparatus, or a stitching apparatus, but the present disclosure is not limited thereto. The electronic devices may be a bent or a flexed device. The display apparatus may be a non-self light emitted type display device or a self light emitted type display device. The antenna apparatus may be a liquid-crystal state device apparatus or a non-liquid-crystal state antenna device. The sensor apparatus may be a sensor device that senses capacitance, light rays, heat energy, or supersonic wave, but the present disclosure is not limited thereto. The electronic devices may include passive components or active components, for example, capacitors, resistors, inductors, diodes, transistors, or the like. The diodes may include a light emitting diode (LED) or a photodiode (PD). The light emitting diode may include for example an organic light emitting diode (OLED), a mini light emitting diode, a micro light emitting diode (μLED), or a quantum dot light emitting diode, but the present disclosure is not limited thereto. The stitching apparatus may be a display stitching device or an antenna stitching device, but the present disclosure is not limited thereto. It should be noted that the electronic devices may be any combinations of the aforementioned devices, but the present disclosure is not limited thereto. The following context may use the display apparatus or the stitching apparatus as the electronic devices to describe the subject matter of the present disclosure, but the present disclosure is not limited thereto.

Furthermore, the appearance of the electronic devices may be rectangular-shape, circular-shape, polygon-shape, curved edges-shape, or the like. The electronic devices may have a processing system, a driving system, a control system, a light source system, a shelf system, and other peripheral systems to support the display apparatus or the stitching apparatus. It should be noted that the electronic devices may be any combinations of the aforementioned systems, but the present disclosure is not limited thereto.

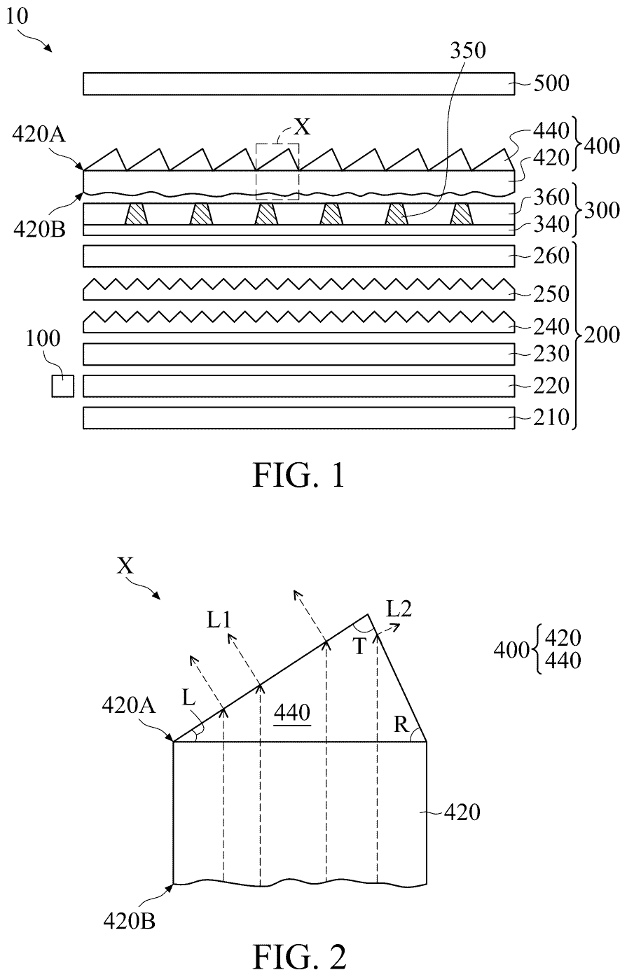

FIG. 1 is a cross-sectional view of an electronic device 10, according to some embodiments of the present disclosure. For clarity, FIG. 1 only shows some elements, for illustration purpose, while other elements of the display device 10 are omitted. In some embodiments, additional elements may be incorporated into the electronic device 10 described below. In some embodiments, some elements of the electronic device 10 described below may be replaced or omitted. In some embodiments, additional operations may be provided before, during, and/or after the formation of the electronic device 10. In some embodiments, some operations described may be replaced or omitted, and the order of some operations described may be interchanged.

For non-self light emitted electronic devices, it is necessary to integrate a backlight module to transmit the light toward an overlying panel. In contrast, for self light emitted electronic device, the light emitted from the light emitted panel may be transmitted toward an overlying protective substrate. The light emitted from the backlight module or the light emitted panel may be measured to obtain an optical diagram. In an example of the electronic device (such as a vehicle dashboard), when viewing angles of the optical diagram need to be restricted for safety concerns, a viewing angle control element may be introduced to reduce the luminous intensity at the upper portion and/or the lower portion of the optical diagram. The viewing angle control element may include for example configurations of a grating structure or the like, and the grating structure may serve as a blocking wall structure to absorb an excessive amount of light. Therefore, the viewing angle control element may also be known as a privacy filter.

The electronic device of the present disclosure may have a special design of a light modulation element to be integrated with other elements. When the light modulation element is designed to have asymmetrical prism structures, the optical propagations may be adjusted to any desired direction. From the cross-sectional view, the prism structures may appear to be triangular-shaped, for example, which has two bottom angles at opposite sides and an overlying top angle. When the prism structures are asymmetrical, the two bottom angles are different from each other. When the light travels through the light modulation element, since the smaller bottom angle has a longer hypotenuse, a larger amount of light is directed to the hypotenuse of the smaller angle, which in turn realizes the alteration and the adjustment of the optical propagation, for example. In other words, the optical diagram may be shifted toward the anticipated direction by designing different top and bottom angles of the prism structures. The tilt angle of the optical diagram (or a cono diagram) may be defined as the intersecting angle between the user's vision and the normal direction of the optical diagram. In some embodiments, in addition to using the viewing angle control element to restrict the scope of the luminous intensity of the optical diagram, the position of the maximum luminous intensity of the optical diagram may be further adjusted through the incorporation of the light modulation element. For example, the position of maximum luminous intensity may be adjusted to a tilt angle of between 5° and 40° (5°≤the tilt angle≤40°, according to the application requirements. In some embodiments, the position of the maximum luminous intensity of the optical diagram may be adjusted to a tilt angle of between 10° and 60° (10°≤the tilt angle≤60°, according to the application requirements. In some embodiments, the top angle of the prism structures may appear slightly arc-shape (not shown).

In some embodiments, the electronic device 10 may include a backlight module 200, a viewing angle control element 300, a light modulation element 400, and/or a panel 500, but the present disclosure is not limited thereto. In some embodiments, the backlight module 200 may include a light source 100, a reflector 210, a light guide plate (LGP) 220, an optical element 230 (for example, a diffuser film), an optical element 240 (for example, a brightness enhancement film (BEF)), an optical element 250 (for example, a brightness enhancement film), and an optical element 260 (for example, a dual brightness enhancement film (DBEF)).

In some embodiments, the viewing angle control element 300 may be disposed for example between the backlight module 200 and the panel 500. The viewing angle control element 300 may include for example a base material 340, a plurality of blocking walls 350, and a filling material 360. The plurality of blocking walls 350 may be disposed on the base material 340, for example, and they may be spaced apart from each other. The filling material 360 may be disposed between the plurality of blocking walls 350, for example, but the present disclosure is not limited thereto. The shape of the plurality of blocking walls 350, or the pitch between them, may be adjusted, according to the application requirements. In other embodiments, the thickness of the filling material 360 in the normal direction of the base material 340 may be different from the thickness of the plurality of blocking walls 350 (not shown).

In some embodiments, the light modulation element 400 may be disposed for example between the panel 500 and the viewing angle control element 300. The light modulation element 400 may include a base material 420 and a plurality of prism structures 440. The plurality of prism structures 440 may be disposed on the surface of the base material 420, for example.

Referring to FIG. 1, the light source 100 of the backlight module 200 may be disposed near the light guide plate 220. In some embodiments, the light source 100 may be a side-entry back light unit (BLU), but the present disclosure is not limited thereto. For example, the light source 100 may also be a straight-down back light unit. In some embodiments, the light source 100 may include quantum dot (QD) material, fluorescence material, phosphor (fluorescent) material, light emitting diode, micro light emitting diode, the like, or a combination thereof, but the present disclosure is not limited thereto.

Still referring to FIG. 1, the reflector 210 of the backlight module 200 may be located below the light guide plate 220. According to some embodiments of the present disclosure, for the light rays emitted from the light guide plate 220 and travelled downward, the reflector 210 may reflect such light rays upward, in order to enhance the utilization of the light.

According to some embodiments of the present disclosure, the light guide plate 220 may selectively include grid points to direct the light from the adjacent light source 100 to be transmitted upward. When the light source 100 is the straight-down back light unit, the disposition of the light guide plate 220 would not be necessary.

Referring to FIG. 1, the optical element 230 (for example, the diffuser film), the optical element 240 (for example, the brightness enhancement film), the optical element 250 (for example, the brightness enhancement film), and/or the optical element 260 (for example, the dual brightness enhancement film) may be sequentially disposed above the light guide plate 220, but the present disclosure is not limited thereto. The optical element 230 and the optical element 260 may selectively have the diffusion function, while the optical element 240 and the optical element 250 may have prism structures. It should be appreciated that the extending direction of the prism structures of the optical element 240 may be different from the extending direction of the prism structures of the optical element 250, for example the extending direction of the prism structures of the optical element 240 and the extending direction of the prism structures of the optical element 250 may be substantially perpendicular with each other, but the present disclosure is not limited thereto.

From the cross-sectional view, the prism structures of the optical element 240 and the optical element 250 may be substantially identical triangle shapes that are continuously arranged. These triangle shapes may have, for example, a symmetrical triangular structure, with a top angle of 90° and two bottom angles of 45° each, but the present disclosure is not limited thereto.

In some embodiments, the optical element 260 may be located above the optical element 250. According to some embodiments of the present disclosure, the optical element 260 may enhance the light converging effect of the electronic device 10, for example.

Referring to FIG. 1, the viewing angle control element 300 may be disposed above the backlight module 200. The viewing angle control element 300 may be disposed for example between the backlight module 200 and the panel 500. According to some embodiments of the present disclosure, the viewing angle control element 300 may restrict the viewing angle of the optical diagram, the scope of the restricted viewing angle of the optical diagram is based on the application and the design requirements (for example, the safety concerns).

In some embodiments, as mentioned above, the plurality of blocking walls 350 may be disposed on the base material 340, and the plurality of blocking walls 350 may be made of light absorbing materials. Whether from the top view or from a cross-sectional view, the plurality of blocking walls 350 may have any suitable geometrical shape, as long as the viewing angle of the optical diagram is restricted based on the design requirements. The materials of the plurality of blocking walls 350 may include black photoresist, black ink, or the like.

According to some embodiments of the present disclosure, the filling materials 360 may include for example light-transmissive materials. The materials of the filling material 360 may include transparent resins, such as polyethylene terephthalate (PET) resins, polycarbonate (PC) resins, polyimide (PI) resins, polymethylmethacrylates (PMMA), polystyrene resins, polyethersulfone (PES) resins, polythiophene (PT) resins, phenol novolac (PN), the like, or a combination thereof, but the present disclosure is not limited thereto.

Referring to FIG. 1, the light modulation element 400 may be disposed above the viewing angle control element 300. The light modulation element 400 may be disposed between the panel 500 and the viewing angle control element 300. The light modulation element 400 may adjust the maximum luminous intensity of the optical diagram to any desired direction. As mentioned previously, the light modulation element 400 may include a plurality of prism structures 440. When the plurality of prism structures 440 are asymmetrical (for example, having two bottom angles at opposite sides that are different from each other), the maximum luminous intensity of the optical diagram may be offset from a center point of the optical diagram. According to some embodiments of the present disclosure, after the light emitted from the backlight module 200 is transmitted through the viewing angle control element 300 and the light modulation element 400, a first optical diagram may be measured at the surface of the light modulation element 400 away from the backlight module 200. The maximum luminous intensity of the first optical diagram may be positioned at a tilt angle θ of between 5° and 40° (5°≤the tilt angle θ≤40°), but the present disclosure is not limited thereto. According to some embodiments of the present disclosure, the maximum luminous intensity of the first optical diagram may be positioned at a tilt angle θ of between 5° and 30° (5°≤the tilt angle θ≤30°), for example at a tilt angle θ of 8° or 17.5°, but the present disclosure is not limited thereto.

According to some embodiments of the present disclosure, the light modulation element 400 may be disposed between the viewing angle control element 300 and the panel 500. The light modulation element 400 may be disposed for example above the viewing angle control element 300. The light emitted for example from the backlight module 200 may first be transmitted through the viewing angle control element 300, followed by transmitting through the light modulation element 400. It should be appreciated that the viewing angle of the output light may first be restricted by the viewing angle control element 300, and then the optical path may be adjusted to the desired propagation. In doing so, both the effect of viewing angle restriction and the effect of optical path adjustment may be taken into account.

If the propagation of the optical diagram is first adjusted by the light modulation element 400, the maximum luminous intensity of the optical diagram at present time would have been adjusted to other directions (for example, the maximum luminous intensity is not positioned in the direction where the tilt angle θ is 0°. If such adjusted light is further transmitted through the viewing angle control element 300 subsequently, the scope of the optical diagram may be overly restricted, which in turn affects the performance of the output light. In other words, the light may be severely consumed. Therefore, if the relative positions of the viewing angle control element 300 and the light modulation element 400 are changed, the advantage of the present disclosure may be lost.

In some embodiments, the base material 420 may serve as a base for the plurality of prism structures 440. The thickness of the base material 420 may be between 25 μm and 350 μm, but the present disclosure is not limited thereto. The refractive index of the base material 420 may be between 1.40 and 1.70, for example between 1.49 and 1.66, but the present disclosure is not limited thereto. The materials of the base material 420 may include polyethylene terephthalate resins, polycarbonate resins, polymethylmethacrylates, or the like, but the present disclosure is not limited thereto. In other embodiments, the base material 420 may also be a retardation film, such as a super retardation film (SRF).

The base material 420 of the light modulation element 400 may have a first surface 420A and a second surface 420B. The plurality of prism structures 440 may be arranged on the first surface 420A, and the first surface 420A may be a planar surface, for example. The second surface 420B may be located opposite to the first surface 420A, and away from the plurality of prism structures 440. The second surface 420B may be the surface of the light modulation element 400 away from the plurality of prism structures 440. In comparison with the first surface 420A of the planar surface, the second surface 420B may have a relatively rough surface. The rough features of the second surface 420B may be used to improve optical grade, or to enhance anti-scratch characteristic. According to some embodiments of the present disclosure, the arithmetic mean deviation (Ra) of the second surface 420B may be between 0.1 μm and 100 μm (0.1 μm≤Ra≤100 μm), between 1 μm and 80 μm (1 μm≤Ra≤80 μm), or between 2 μm and 60 μm (2 μm≤Ra≤60 μm), but the present disclosure is not limited thereto. In some embodiments, the roughness of the second surface 420B may be realized through laser etch, but the present disclosure is not limited thereto. In some embodiments, the roughness of the second surface 420B of the base material 420 may be realized by hard coating, matte layer, or beads coating, but the present disclosure is not limited thereto.

In some embodiments, the plurality of prism structures 440 may be disposed on the base material 420. The plurality of prism structures 440 may be tightly adjoined with each other, without any space between them, for example, but the present disclosure is not limited thereto. As mentioned previously, the plurality of prism structures 440 may be asymmetrical (for example, having two bottom angles at opposite sides that are different from each other). The materials of the plurality of prism structures 440 may include a low refractive index glue, a high refractive index glue, titanium dioxide (TiO₂), or the like. The refractive index of the low refractive index glue may be between 1.50 and 1.59, while the refractive index of the high refractive index glue may be between 1.60 and 1.70.

Referring to FIG. 1, the panel 500 may be disposed above the light modulation element 400. According to some embodiments of the present disclosure, the panel 500 may be used to display the light at the desired viewing angle and tilt angle. In the present embodiment, the panel 500 may be non-self light emitted, but the present disclosure is not limited thereto. The panel 500 may include a lower substrate (not shown), an upper substrate (not shown), a lower polarizer (not shown), an upper polarizer (not shown), and a display layer (for example, a liquid-crystal layer) located between the lower substrate and the upper substrate. The panel 500 may include twisted nematic (TN) mode, in-plane switching (IPS) mode, fringe field switching (FFS) mode, multi-quadrant vertical alignment (MVA) mode, patterned vertical alignment (PVA) mode, the like, or a combination thereof, but the present disclosure is not limited thereto.

FIG. 2 is an enlarged view of a region X in the electronic device 10 shown in FIG. 1, according to some embodiments of the present disclosure. In some embodiments, the light modulation element 400 may have a base material 420 and a plurality of prism structures 440. The base material 420 may include the first surface 420A and the second surface 420B. The plurality of prism structures 440 may be disposed on the first surface 420A, and the second surface 420B opposite from the first surface 420A may have a relatively high arithmetic mean deviation. For simplicity and clarity, FIG. 2 illustrates only one of the plurality of prism structures 440. For illustrative purpose, the backlight module 200, the viewing angle control element 300, and the panel 500 are omitted.

Referring to FIG. 2, the prism structure 440 may have a top angle T, a first bottom angle (such as a right bottom angle R), and a second bottom angle (such as a left bottom angle L). Based on the principle of geometry, the sum of the three angles of every triangle shape is 180°. More specifically, the sum of the top angle T, the first bottom angle (such as the right bottom angle R), and the second bottom angle (such as the left bottom angle L) is 180°. It is worth noted that the first bottom angle (such as the right bottom angle R) is for example larger than the second bottom angle (such as the left bottom angle L), and the ratio of the first bottom angle (such as the right bottom angle R) to the second bottom angle (such as the left bottom angle L) satisfies the following condition: 1<the first bottom angle (such as the right bottom angle R)/the second bottom angle (such as the left bottom angle L)≤15.

For example, the ratio of the first bottom angle (such as the right bottom angle R) to the second bottom angle (such as the left bottom angle L) satisfies the following condition: 3<the first bottom angle (such as the right bottom angle R)/the second bottom angle (such as the left bottom angle L)≤13, 4<the first bottom angle (such as the right bottom angle R)/the second bottom angle (such as the left bottom angle L)≤12, or 5<the first bottom angle (such as the right bottom angle R)/the second bottom angle (such as the left bottom angle L) ≤11, but the present disclosure is not limited thereto.

In some embodiment, the top angle T may be between 30° and 150° (30°≤the top angle T≤150°), between 35° and 145° (35°≤the top angle T≤145°), between 40° and 140° (40°≤the top angle T≤140°, between 45° and 135° (45°≤the top angle T≤135°), or between 45° and 90° (45°≤the top angle T≤90°), but the present disclosure is not limited thereto.

In some embodiments, the first bottom angle (such as the right bottom angle R) or the second bottom angle (such as the left bottom angle L) may be between 2° and 90° (2°≤the first bottom angle (such as the right bottom angle R) or the second bottom angle (such as the left bottom angle L)≤90°), between 10° and 80° (10°≤the first bottom angle (such as the right bottom angle R) or the second bottom angle (such as the left bottom angle L)23 80°), between 15° and 75° (15°≤the first bottom angle (such as the right bottom angle R) or the second bottom angle (such as the left bottom angle L)≤75°), or between 20° and 70° (20°≤the first bottom angle (such as the right bottom angle R) or the second bottom angle (such as the left bottom angle L)≤70°), but the present disclosure is not limited thereto. In some embodiments, the top angle T may be larger than or equal to the sum of the first bottom angle (such as the right bottom angle R) and the second bottom angle (such as the left bottom angle L). For example, the top angle T may be between 90° and 150° (90°≤the top angle T≤150°), and the sum of the first bottom angle (such as the right bottom angle R) and the second bottom angle (such as the left bottom angle L) equals to 180° subtracted by the top angle T. In some embodiments, the top angle T may be smaller than the sum of the first bottom angle (such as the right bottom angle R) and the second bottom angle (such as the left bottom angle L). For example, the top angle T may be between 30° and 89° (30°≤the top angle T≤89°), between 35° and 85° (35°≤the top angle T≤85°), or between 40° and 80° (40°≤the top angle T≤80°), and the sum of the first bottom angle (such as the right bottom angle R) and the second bottom angle (such as the left bottom angle L) equals to 180° subtracted by the top angle T. In some embodiments, the first bottom angle (such as the right bottom angle R) of at least one of the plurality of prism structures 440 may be 90°.

Referring to FIG. 2, after the light emitted from the viewing angle control element 300 is transmitted through the light modulation element 400, the light may have a light ray L1 and a light ray L2. As mentioned previously, since the smaller bottom angle has a longer hypotenuse, a larger amount of light may be directed to the hypotenuse of the smaller bottom angle. For example, the second bottom angle (such as the left bottom angle L) is smaller than the first bottom angle (such as the right bottom angle R), the hypotenuse corresponding to the second bottom angle (such as the left bottom angle L) is longer than the hypotenuse corresponding to the first bottom angle (such as the right bottom angle R). Therefore, light ray L1 is larger than light ray L2. The two bottom angles of the opposite sides may be altered by adjusting every prism structure 440, so a larger amount of light may be directed in the desired direction, which in turn allows the maximum luminous intensity of the overall optical diagram of the electronic device 10 to be positioned at the desired tilt angle.

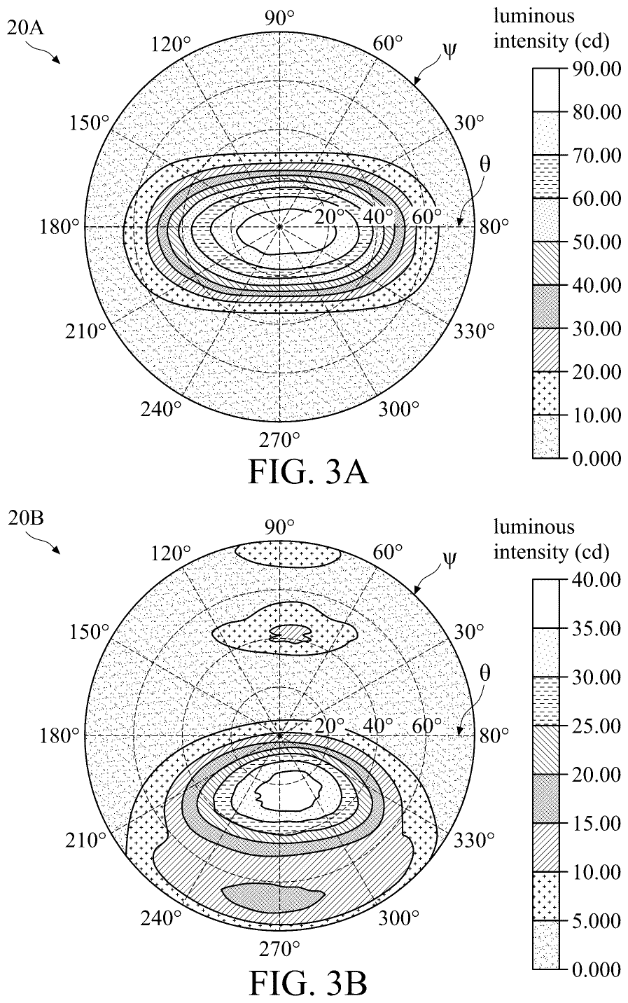

In some embodiments, the optical diagram may be measured by an angle analysis instrument (for example, Model DMS-803), an image spectral chromatometer (for example, a conometer), or the like. The optical diagram may have an azimuth angle Ψ and a tilt angle θ. The azimuth angle Ψ may be within a range of 0° to 360°. The azimuth angle Ψ may be considered the angle corresponding to different direction on the plane of the panel 500. For example, the light source 100 may be close to the azimuth angle Ψ of 270°. The tilt angle θ may be within a range of 0° to 80°, but the present disclosure is not limited thereto. The tilt angle θ may be considered as the intersecting angle between the user's vision and the normal direction of the surface of the panel 500. For example, when the tilt angle θ is 0°, the tilt angle θ is parallel with the normal direction of the panel 500. In contrast, when the tilt angle θ increases, the tilt angle θ approaches the direction of the horizontal surface of the panel 500. FIG. 3A is an optical diagram 20A of an electronic device, according to some comparative examples. In the electronic device without the disposition of the light modulation element 400, the maximum luminous intensity of the optical diagram 20A may be substantially positioned at for example a normal direction of the user's vision (namely a center point of the optical diagram 20A). Typically, the optical diagram of the light emitted from the backlight module 200 may appear to be a uniform output light across the measured surface, meaning the luminous intensity of the light is evenly distributed among all azimuth angles, but the present disclosure is not limited thereto. When the viewing angle control element 300 is additionally disposed above the backlight module 200, the viewing angle control element 300 may absorb a portion of the light, which in turn restricts the viewing angle of the optical diagram. For example, the electronic device depicted in FIG. 3A may appear to have the optical diagram 20A with viewing angle restricted at the upper portion and the lower portion. That is, under the same tilt angle θ, the luminous intensity positioned at an azimuth angle Ψ of between 60° and 120° and at an azimuth angle Ψ of between 240° and 300° is smaller than the luminous intensity positioned at azimuth angles Ψ of other ranges, but the present disclosure is not limited thereto. In other embodiments, the placement angle of the viewing angle control element 300 may be adjusted, so the electronic device may appear to have an optical diagram with the viewing angle restricted at the left portion and the right portion (not shown), but the present disclosure is not limited thereto.

FIG. 3B is an optical diagram 20B of the electronic device 10, according to some embodiments of the present disclosure. In comparison with the optical diagram 20A, the optical diagram 20B measures the electronic device 10 with the light modulation element 400 of the present disclosure. In comparison with the optical diagram 20A (with the maximum luminous intensity positioned at a tilt angle θ close to 0°), the disposition of the light modulation element 400 may adjust the tilt angle θ of the maximum luminous intensity of the optical diagram 20B according to the design of the light modulation element 400.

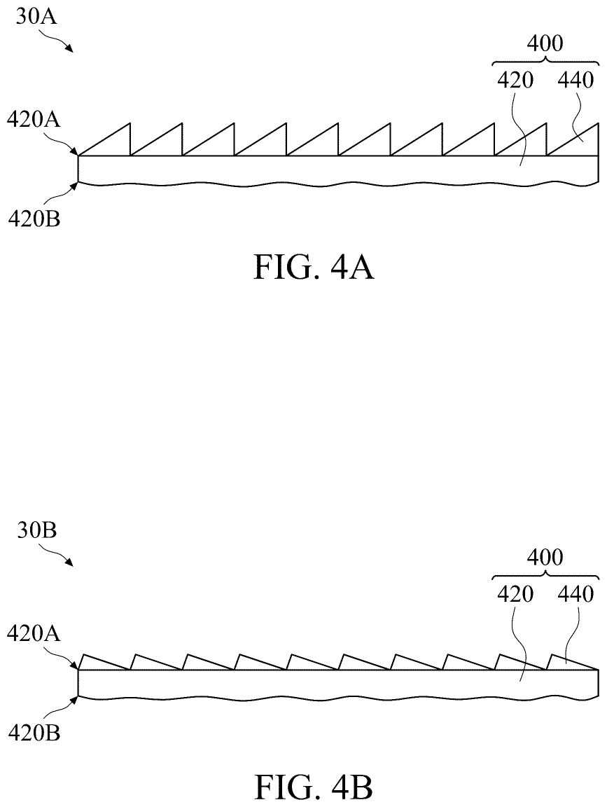

FIGS. 4A and 4B are cross-sectional views of various designs of light modulation elements 400 of electronic devices 30A and 30B, according to some embodiments of the present disclosure. In comparison with the electronic device 10, the plurality of prism structures 440 of the light modulation element 400 of the electronic devices 30A and 30B may have substantially identical structures. For illustrative purpose, other elements are omitted. The features of the light modulation element 400 may be similar to that shown in FIG. 1, and the details are not described again herein to avoid repetition.

Referring to FIG. 4A, the cross-sectional view of the light modulation element 400 of the electronic device 30A is illustrated. The top angle, the second bottom angle (such as the left bottom angle), and the first bottom angle (such as the right bottom angle) of every prism structure 440 of the light modulation element 400 may be 58°, 32°, and 90°, respectively, but the present disclosure is not limited thereto. It is worth noted that the top angle of the prism structure 440 is smaller than the sum of the second bottom angle (such as the left bottom angle) and the first bottom angle (such as the right bottom angle), and the first bottom angle (such as the right bottom angle) may be a right angle, for example, but the present disclosure is not limited thereto. According to some embodiments of the present disclosure, the plurality of prism structures 440 may be asymmetrical (for example, the second bottom angle (such as the left bottom angle) and the first bottom angle (such as the right bottom angle) are different from each other), thereby achieving the desired optical propagation.

Referring to FIG. 4B, the cross-sectional view of the light modulation element 400 of the electronic device 30B is illustrated. The top angle, the second bottom angle (such as the left bottom angle), and the first bottom angle (such as the right bottom angle) of every prism structure 440 of the light modulation element 400 may be 90°, 72°, and 18°, respectively, but the present disclosure is not limited thereto. It is worth noted that the top angle of the prism structure 440 is equal to the sum of the second bottom angle (such as the left bottom angle) and the first bottom angle (such as the right bottom angle), and the top angle may be a right angle, for example. According to some embodiments of the present disclosure, the plurality of prism structures 440 may be asymmetrical (for example, the second bottom angle (such as the left bottom angle) and the first bottom angle (such as the right bottom angle) are different from each other), thereby achieving the desired optical propagation.

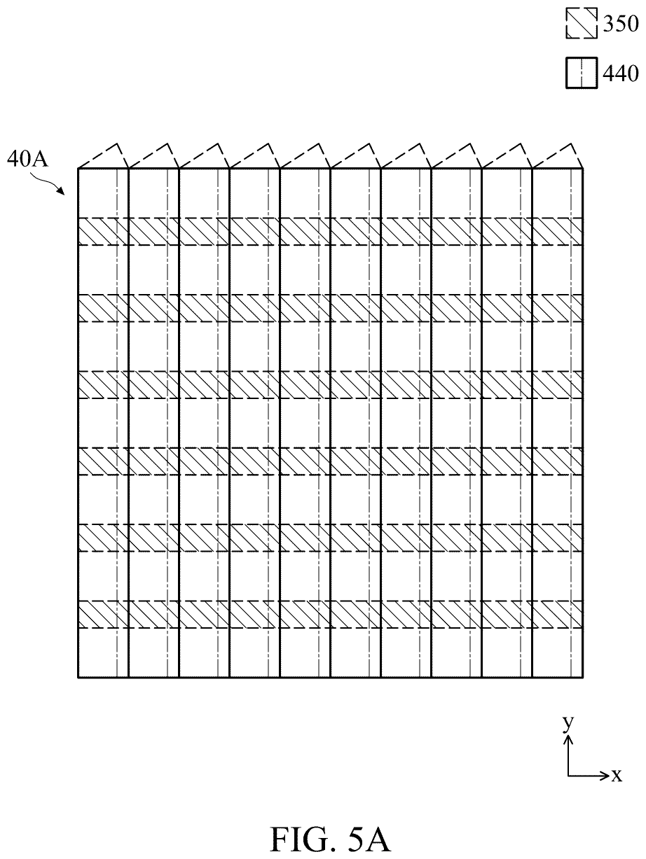

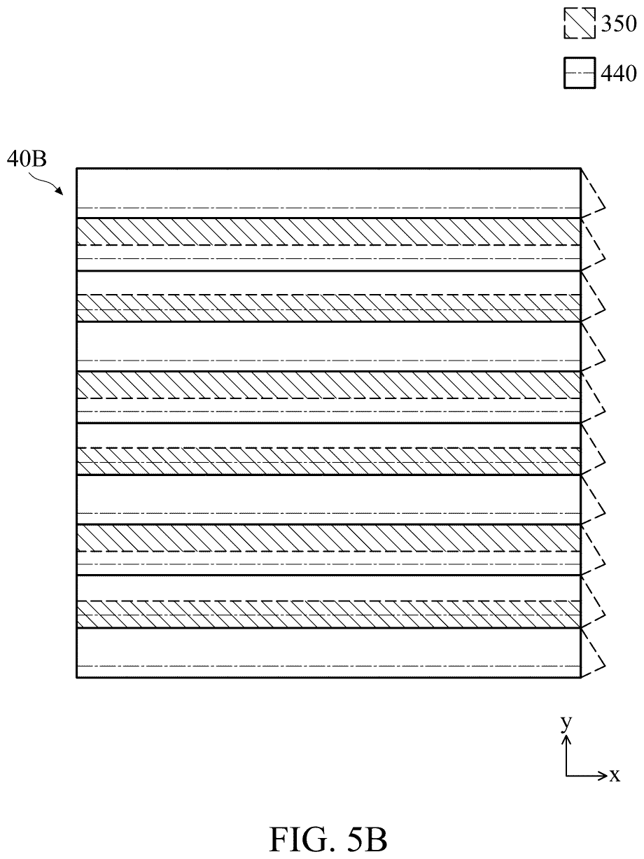

FIGS. 5A and 5B are top views of various designs of electronic devices 40A and 40B, according to some embodiments of the present disclosure. The configuration of the viewing angle control element 300 and the light modulation element 400 may be varied. For illustrative purpose, other elements are omitted. The features of the viewing angle control element 300 and the light modulation element 400 may be similar to those shown in FIG. 1, and the details are not described again herein to avoid repetition.

Referring to FIG. 5A, the top view of the electronic device 40A is illustrated. The viewing angle control element 300 may have a plurality of blocking walls 350 that extend in the first direction (for example, the x-axis direction), while the plurality of prism structures 440 of the light modulation element 400 may extend in the second direction (for example, the y-axis direction). The extending direction (the first direction) of the plurality of blocking walls 350 may be different from the extending direction (the second direction) of the plurality of the prism structures 440. For example, the first direction and the second direction may be perpendicular with each other, or the first direction and the second direction may intersect at an angle of 45° to 80°, but the present disclosure is not limited thereto. The dashed line within every prism structure 440 may be seen as the position of the top angle of the triangle profile. Furthermore, the cross-sectional view of the plurality of prism structures 440 of FIG. 1 is also labelled using dashed lines to serve as a reference for the relative position. The viewing angle of the optical diagram of the electronic device 40A may be restricted in the vertical direction, for example, and it may be offset in the horizontal direction, but the present disclosure is not limited thereto.

Referring to FIG. 5B, the top view of the electronic device 40B is illustrated. The viewing angle control element 300 may have a plurality of blocking walls 350 that may extend in the first direction (for example, the x-axis direction), while the plurality of prism structures 440 of the light modulation element 400 may extend in the first direction (for example, the x-axis direction). The extending direction of the plurality of blocking walls 350 and the extending direction of the plurality of the prism structures 440 may be substantially the same. The dashed line within every prism structure 440 may be seen as the position of the top angle of the triangle profile. Furthermore, the cross-sectional view of the plurality of prism structures 440 of FIG. 1 is also labelled using dashed lines to serve as a reference for the relative position. The viewing angle of the optical diagram of the electronic device 40B may be restricted in the vertical direction, for example, and it may be offset in the vertical direction, but the present disclosure is not limited thereto.

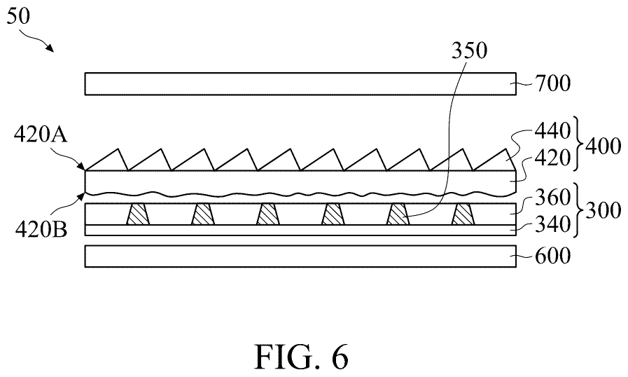

FIG. 6 is a cross-sectional view of an electronic device 50, according to other embodiments of the present disclosure. In comparison with FIG. 1, the electronic device 50 may have a self light emitted panel 600, and a protective substrate 700 disposed above the panel 600. Because of the self light emitted characteristic of the panel 600, the electronic device 50 may no longer need the backlight module 200. The features of the viewing angle control element 300 and the light modulation element 400 may be similar to those shown in FIG. 1, and the details are not described again herein to avoid repetition.

Referring to FIG. 6, the protective substrate 700 may be disposed above the panel 600. The materials of the protective substrate 700 may include cover glass (CG) or the like.

Still referring to FIG. 6, the light modulation element 400 may be disposed between the panel 600 and the protective substrate 700. The viewing angle control element 300 may be disposed between the panel 600 and the light modulation element 400, and the light modulation element 400 may be disposed between the viewing angle control element 300 and the protective substrate 700. As mentioned previously, the light modulation element 400 needs to be disposed for example above the viewing angle control element 300 to reduce a large consumption of the light.

According to alternative embodiments of the present disclosure, only the light modulation element 400 may be disposed between the panel 600 and the protective substrate 700, and the viewing angle control element 300 may be selectively omitted.

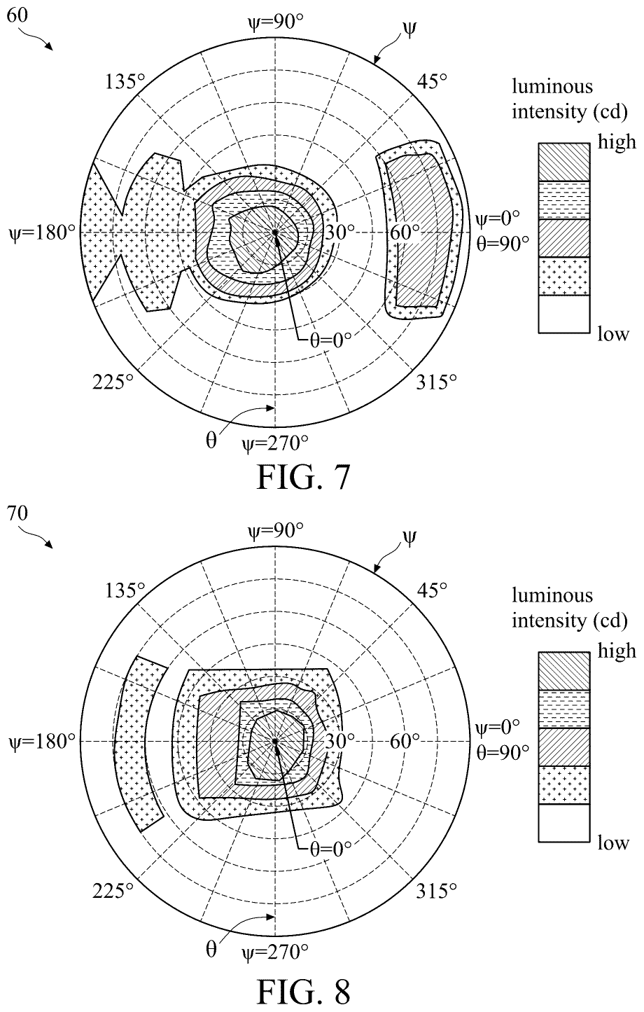

FIGS. 7 and 8 are simulated optical diagrams 60 and 70 of various designs of electronic devices, according to some embodiments of the present disclosure. During the simulation, the relative position of the light source 100 may be close to the azimuth angle Ψ of 270°, for example. The refractive index of the plurality prism structures 440 of the simulated light modulation element 400 may be between 1.56 and 1.70, for example. The second surface 420B of the base material 420 of the simulated light modulation element 400 may have the arithmetic mean deviation between 0.1 μm and 30 μm, and a haze between 0% and 20%. The haze may be related to the arithmetic mean deviation.

Referring to FIG. 7, the simulated optical diagram 60 of the electronic device is illustrated. The top angle, the second bottom angle (such as the left bottom angle), and the first bottom angle (such as the right bottom angle) of every prism structure 440 of the light modulation element 400 may be 80°, 55°, and 45°, respectively. It is worth noted that the top angle of the prism structure 440 is smaller than the sum of the second bottom angle (such as the left bottom angle) and the first bottom angle (such as the right bottom angle), and there are no right angles. It is worth noted that the luminous intensity distribution between the left half portion and the right half portion of the simulated optical diagram 60 are different. According to some embodiments of the present disclosure, the plurality of prism structures 440 may be asymmetrical (for example, the second bottom angle (such as the left bottom angle) and the first bottom angle (such as the right bottom angle) are different from each other), thereby achieving the desired optical propagation.

Still referring to FIG. 7, the optical diagram 60 may have an azimuth angle Ψ and a tilt angle θ. The azimuth angle Ψ may be within a range of 0° to 360°. The azimuth angle may be considered as an angle corresponding to a different direction on the plane of the panel 500. For example, the light source 100 may be close to the azimuth angle Ψ of 270°. The tilt angle θ may, for example, be within a range of 0° to 90°, but the present disclosure is not limited thereto. The tilt angle θ may be considered as the intersecting angle between the user's vision and the normal direction of the surface of the panel 500. For example, when the tilt angle θ is 0°, the tilt angle θ is parallel with the normal direction of the panel 500. In contrast, when the tilt angle θ increases, the tilt angle θ approaches the direction of the horizontal surface of the panel 500.

Referring to FIG. 8, the simulated optical diagram 70 of the electronic device is illustrated. The top angle, the second bottom angle (such as the left bottom angle), and the first bottom angle (such as the right bottom angle) of every prism structure 440 of the light modulation element 400 may be 100°, 35°, and 45°, respectively. It is worth noted that the top angle of the prism structure 440 is larger than the sum of the second bottom angle (such as the left bottom angle) and the first bottom angle (such as the right bottom angle), and there are no right angles. It is worth noted that the luminous intensity distribution between the left half portion and the right half portion of the simulated optical diagram 70 are different. According to some embodiments of the present disclosure, the plurality of prism structures 440 may be asymmetrical (for example, the second bottom angle (such as the left bottom angle) and the first bottom angle (such as the right bottom angle) are different from each other), thereby achieving the desired optical propagation.

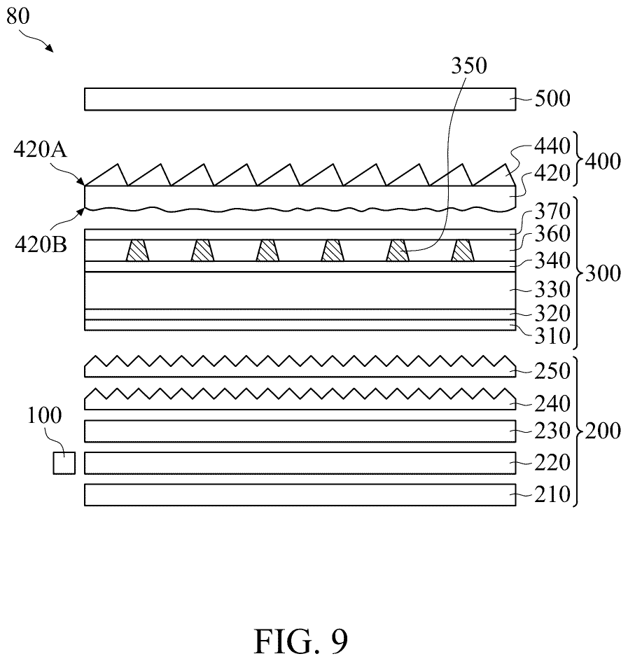

FIG. 9 is a cross-sectional view of an electronic device 80, according to other embodiments of the present disclosure. In comparison with FIG. 1, the viewing angle control element 300 of the electronic device 80 may include a lower plate 310, an adhesion layer 320, an optical element 330 (for example, a dual brightness enhancement film or the like), and an upper plate 370. The features of the backlight module 200, the light modulation element 400, and the panel 500 may be similar to those shown in FIG. 1, and the details are not described again herein to avoid repetition.

Referring to FIG. 9, the lower plate 310 may be provided. According to some embodiments of the present disclosure, the lower plate 310 may be functioned for example to support or to protect the optical element 330 from the underlying structure. According to a specific embodiment of the present disclosure, the lower plate 310 may include polycarbonate resin-based materials or the like, but the present disclosure is not limited thereto.

Referring to FIG. 9, the adhesion layer 320 may be functioned for example to fix the optical element 330 with the lower plate 310.

In some embodiments, since the viewing angle control element 300 has already included the optical element 330, the optical element 260 of the backlight module 200 may be omitted. From another perspective, the optical element 260 of the backlight module 200 may be integrated into the viewing angle control element 300.

Still referring to FIG. 9, the base material 340, the plurality of blocking walls 350, and the filling material 360 may be located between the optical element 330 and the upper plate 370. According to some embodiments of the present disclosure, the upper plate 370 may be functioned for example to protect the plurality of blocking walls 350, but the present disclosure is not limited thereto.

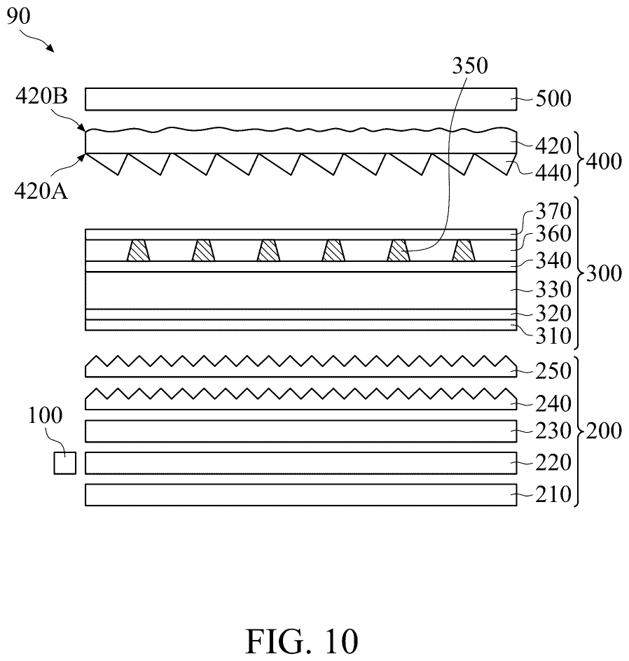

FIG. 10 is a cross-sectional view of an electronic device 90, according to other embodiments of the present disclosure. In comparison with FIG. 9, the plurality of prism structures 440 of the light modulation element 400 of the electronic device 90 may be disposed upside down. The features of the backlight module 200, the viewing angle control element 300, the light modulation element 400, and the panel 500 may be similar to those shown in FIG. 9, and the details are not described again herein to avoid repetition.

Referring to FIG. 10, the plurality of prism structures 440 of the light modulation element 400 may face the underlying viewing angle control element 300, for example. The relatively rough second surface 420B of the light modulation element 400 may be close to the panel 500, but the present disclosure is not limited thereto. Although the configuration and the direction of the plurality of prism structures 440 may vary, the optical propagation may still be altered by adjusting the two bottom angles on the opposite sides (or the two intersecting angles with the first surface 420A). According to some embodiments of the present disclosure, the plurality of prism structures 440 may be asymmetrical (for example, the two bottom angles on the opposite sides are different from each other), thereby achieving the desired optical propagation.

The viewing angle of the light may be adjusted to any desired direction by integrating an innovative light modulation element with the asymmetrical prism structures. When the plurality of prism structures are asymmetrical, the two bottom angles on the opposite sides are different from each other. Since the smaller bottom angle has a longer hypotenuse, a greater amount of light may be directed to the hypotenuse of the smaller angle, which in turn realizes the alteration and the adjustment of the optical propagation. In other words, the maximum luminous intensity of the optical diagram may be offset from the normal direction of the user's vision by designing different prism structures. The offset direction may be interested with the original normal direction, and the intersecting angle may serve as the tilt angle of the optical diagram. In addition to use the present viewing angle control element to restrict the viewing angle of the optical diagram, the light modulation element may further adjust the position of the maximum luminous intensity, for example at a tilt angle between 5° and 40°. Furthermore, the light modulation element needs to be located above the viewing angle control element to demonstrate the advantage of the present disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An electronic device, comprising:
a backlight module;
a panel disposed on the backlight module;
a viewing angle control element disposed between the backlight module and the panel; and
a light modulation element disposed between the panel and the viewing angle control element, wherein the light modulation element has a plurality of prism structures, and at least one of the plurality of prism structures comprises a first bottom angle and a second bottom angle, the first bottom angle is larger than the second bottom angle, and a ratio of the first bottom angle to the second bottom angle satisfies 1<the first bottom angle/the second bottom angle≤15.

2. The electronic device of claim 1, wherein after a light emitted from the backlight module is transmitted through the viewing angle control element and the light modulation element, a maximum luminous intensity of a first optical diagram is measured from a surface of the light modulation element away from the backlight module, and the maximum luminous intensity is located at a tilt angle (θ) of between 5° and 40°.

3. The electronic device of claim 2, wherein a light source of the backlight module is located at an azimuth angle (Ψ) of 270° in the first optical diagram.

4. The electronic device of claim 3, wherein the backling module further comprising:
a light guide plate (LGP) disposed near the light source;
a reflector located below the light guide plate; and
optical elements diespsed above the light guide plate.

5. The electronic device of claim 4, wherein the optical elements are a diffuser film, a brightness enhancement film (BEF), or a dual brightness enhancement film (DBEF).

6. The electronic device of claim 5, wherein the brightness enhancement film comprises symmetrical prism structures.

7. The electronic device of claim 1, wherein a top angle of at least one of the plurality of prism structures is larger than or equal to a sum of the first bottom angle and the second bottom angle.

8. The electronic device of claim 1, wherein a top angle of at least one of the plurality of prism structures is smaller than a sum of the first bottom angle and the second bottom angle.

9. The electronic device of claim 1, wherein a top angle of at least one of the plurality of prism structures is 90°.

10. The electronic device of claim 1, wherein the first bottom angle of at least one of the plurality of prism structures is 90°.

11. The electronic device of claim 1, wherein an arithmetic mean deviation (Ra) of a surface of the light modulation element away from the plurality of prism structures is between 0.1 μm and 100 μm.

12. The electronic device of claim 1, wherein the viewing angle control element has a plurality of blocking walls extending along a first direction, and the plurality of prism structures extend along a second direction different from the first direction.

13. The electronic device of claim 1, wherein the viewing angle control element has a plurality of blocking walls extending along a first direction, and the plurality of prism structures extend along the first direction.

14. An electronic device, comprising:
a panel;
a protective substrate disposed on the panel; and
a light modulation element disposed between the panel and the protective substrate, wherein the light modulation element has a plurality of prism structures, and at least one of the plurality of prism structures comprises a first bottom angle and a second bottom angle, the first bottom angle is larger than the second bottom angle, and a ratio of the first bottom angle to the second bottom angle satisfies 1<the first bottom angle/the second bottom angle≤15.

15. The electronic device of claim 14, wherein the plurality of prism structures face the protective substrate.

16. The electronic device of claim 14, wherein the plurality of prism structures face the panel.

17. The electronic device of claim 14, further comprising a viewing angle control element disposed between the panel and the light modulation element.

18. The electronic device of claim 17, wherein after a light emitted from the panel is transmitted through the viewing angle control element and the light modulation element, a maximum luminous intensity of a first optical diagram is measured from a surface of the light modulation element away from the panel, and the maximum luminous intensity is located at a tilt angle (θ) of between 5° and 40°.

19. The electronic device of claim 17, wherein the viewing angle control element further comprising:
a base material;
a plurality of blocking walls disposed on the base material; and
a filling material disposed between the plurality of blocking walls.

20. The electronic device of claim 17, wherein the viewing angle control element further comprising:
a lower plate;
an optical element disposed on the lower plate;
a base material disposed on the optical element;
a plurality of blocking walls disposed on the base material;
a filling material disposed between the plurality of blocking walls; and
an upper plate covering the plurality of blocking walls and the filling material.
